(19) United States
(12) Patent Application Publication
(10) Pub. No.: US 2021/0182714 A1
(43) Pub. Date: Jun. 17, 2021

(54) AUDITABLE RULE ENGINE-BASED DIAGNOSTIC TOOLS

(71) Applicant: Cisco Technology, Inc., San Jose, CA (US)

(72) Inventors: Asad Ghayas Ahmed, San Jose, CA (US); Arun Mammen Thomas, Dublin, CA (US); Madhavan Kasthurirangan, Palo Alto, CA (US); Smruti Lele, Milpitas, CA (US); Samer Salam, Beirut (LB)

(21) Appl. No.: 16/818,791

(22) Filed: Mar. 13, 2020

Related U.S. Application Data
(60) Provisional application No. 62/947,814, filed on Dec. 13, 2019.

(51) Int. Cl. G06N 5/04; G06N 5/02

(52) U.S. Cl. CPC G06N 5/045; G06N 5/027

(57) ABSTRACT

This disclosure describes techniques for diagnostic tools rendering auditable reasoning of underlying rule engines. A method includes a computing system running a software tool executing an iteration of an underlying rule engine of the software tool to compute at least one input fact; sending a command over a communication interface to a fact source and obtaining an output from the fact source over the communication interface; recording the output from the fact source in a diagnostic event construct; recording a reference to the diagnostic event construct in an inference construct; displaying information of the inference construct in a conclusion view user interface; and displaying information of the diagnostic event construct referenced by the inference construct in an expanded view user interface.

### RELATED APPLICATIONS

This application claims priority to U.S. Provisional Patent Application No. 62/947,814, filed on Dec. 13, 2019, the entire contents of which are incorporated herein by reference.

### TECHNICAL FIELD

The present disclosure relates generally to diagnostic tools which render auditable reasoning of underlying rule engines.

### BACKGROUND

Many complex technological systems, such as information technology (“IT”) systems deployed in industries such as medical services or banking services, experience failures or errors during operation, and the complexity of these systems may render manual diagnosis of problems by unaided human support personnel inefficient. These technological systems, however, can generally be described by various rules-based models implemented as diagnostic and troubleshooting tools on user-operated computing systems. On a computing system running these diagnostic and troubleshooting tools, based on interactions between known and defined rules, the input of facts may deterministically trigger rules of the rules-based models that lead to intermediate inferences, followed by final conclusions.

A rule engine may generally refer to one or more sets of computer-readable instructions which, when executed by one or more processor(s) of a computing system, cause the computing system to compute one or more input facts based on a set of predetermined rules, outputting intermediate inferences; intermediate inferences may be fed back into the rule engine, causing the computing system to output further stages of intermediate inferences. Upon the rule engine outputting a stage of intermediate inferences which are not different from a previous stage of intermediate inferences, the computing system may determine that the rule engine has reached a conclusion. The computing system may then conclude the rule engine-based computing of facts.

A rule engine performing reasoning in this manner is often a so-called forward chaining rule engine, which is unable to reconstruct a flow of inferences, including intermediate inferences, which led from the input facts to the output conclusion. Support personnel relying on the output conclusion may be unable to trace back or audit the overall reasoning of the output which led to the conclusion. Consequently, support personnel may be rendered unable to fully rely upon the output conclusion, or may be unable to justify conclusions that they rely upon to customers. As lack of transparency may generally limit trust in the providence of the rule engine conclusions, there is a need to provide diagnostic tools which enable auditing of underlying rule engines.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example of a conclusion view user interface of a software tool.

FIG. 2 illustrates an example of a partial workflow of a rule engine.

FIG. 3 illustrates an example of an expanded view user interface of a software tool.

FIG. 4A illustrates a flowchart of an example workflow computing method. FIG. 4B illustrates a flowchart of iterations of a rule engine in accordance with the example workflow computing method.

FIG. 5 illustrates an example system architecture of a computing system configured to run a software tool and perform rule engine computations.

### DESCRIPTION OF EXAMPLE EMBODIMENTS

### Overview

This disclosure describes techniques for diagnostic tools rendering auditable reasoning of underlying rule engines. A method includes a computing system running a software tool executing an iteration of an underlying rule engine of the software tool to compute at least one input fact; sending a command over a communication interface to a fact source and obtaining an output from the fact source over the communication interface; recording the output from the fact source in a diagnostic event construct; recording a reference to the diagnostic event construct in an inference construct; displaying information of the inference construct in a conclusion view user interface; and displaying information of the diagnostic event construct referenced by the inference construct in an expanded view user interface.

Additionally, the techniques described herein may be performed by a system having non-transitory computer-readable media storing computer-executable instructions that, when executed by one or more processors, performs the methods described above.

### EXAMPLE EMBODIMENTS

A variety of software tools are deployed by professionals to access collections of logic for decision-making pertinent in their respective organizations and industries. For example, in the healthcare industry, software tools may automate data collection, recordkeeping, billing, and insurance claims according to rules that govern each, such as data privacy rules and payment processing policies. In the banking industry, software tools may automate decisions which are based on past expertise or trends, such as decisions regarding lending to customers or decisions regarding buying or selling of assets or commodities. The software tools may run on a computing system which provides at least input and output interfaces, and, through the input and output interfaces, may provide any number of user interfaces which enable a user operating the computing system to input facts into the system and review output conclusions.

The computing system may also provide communication interfaces with physical or virtual hardware or software modules of the computing system, and with other computing devices or systems, accessible to the software tool so that it may execute commands, such as command line instructions (“CLIs”) on these other modules, devices, and/or systems, in order to determine hardware or software conditions or metrics to provide additional input facts as may be pertinent to diagnosed scenarios. Where the communication interfaces are network interfaces with host servers on a network, commands may instead be representational state transfer (“REST”) application programming interface (“API”) commands, which may similarly cause hardware or software conditions to be determined and returned over the network interface. Communication interfaces may include, for example, input/output (“I/O”) pins on microprocessors, control buses on CPUs, data buses of computing systems, network interfaces, Universal Serial Bus (“USB”) interfaces, Peripheral Component Interconnect (“PCI”) bus interfaces, Small Computer System Interface (“SCSI”) bus interfaces, Fiber Channel (“FC”) bus interfaces, Peripheral Component Interconnect Express (“PCIe”) bus interfaces, and any other suitable interfaces for device-to-device communication as known to persons skilled in the art.

The software tools may implement decision-making logic underlying their decisions as a rule engine. Alternatively, according to example embodiments of the present disclosure, software tools may, rather than make decisions, be directed to diagnosing causes of scenarios having unknown causes (such software tools may be referred to herein as “diagnostic tools,” and may be generally referred to as “diagnostic tools,” “troubleshooting tools” and the like). Scenarios may include, for example, a variety of failures, problems, errors, bugs, tickets, reports, and the like occurring in a particular technical, industrial, or professional context having a set of rules, such as inference rules, related thereto. Inference rules in such contexts may refer to, for example, knowledge bases regarding causes of scenarios or symptoms of those scenarios, where a cause may be related to a scenario or a symptom thereof by a conditional statement.

Thus, a rule engine may implement rules which describe the functioning of a physical or virtual technological system, such as an IT system, so as to serve as a backend to a diagnostic tool which is run by support personnel assigned to service the technological system. For example, according to example embodiments of the present disclosure, a technological system may be a physical or virtual network environment, which may include network equipment such as routers, switches, gateways, access points, firewalls, network interface controllers, and the like, which may be connected to each other and to one or more networks as known in the art.

In general, these diagnostic systems may be utilized by support personnel to provide assistance, backup, guidance, or substitution for manual reasoning to diagnose the nature of scenarios pertaining to a technological system. The computing system may determine facts regarding symptoms of the problem by observation or collecting logged information obtained over any number of communication interfaces in communication with modules, devices, or systems, and may then run the rule engine, inputting facts obtained from the communication interfaces into the rule engine, receiving output inferences from the rule engine, and conclusions on a user interface displayed by the computing system.

Rule engines generally refer to one or more sets of computer-readable instructions stored on a computer-readable storage medium, such as, for example, an inference rule engine. Such a rule engine, when executed by one or more processor(s) of a computing system, may cause the computing system to forward one or more facts to the rule engine as input; compute the one or more input facts based on a set of predetermined rules defining the rule engine; and obtain inferences output by the rule engine based on the input facts and rules. The predetermined rules, such as inference rules, may be computer-readable instructions which represent logical statements such as conditional (IF . . . THEN . . . ) statements.

For example, in the context of a diagnostic tool for network administration, an inference rule may state that if a router queue contains more than X number of packets from inbound network traffic, then there is network congestion over an inbound port of the router. In this case, X is a numerical threshold of the inference rule, which may be a variable parameter of the rule. Thus, if the threshold number of packets is input as a parameter of the rule, computing the inference rule at an iteration of the rule engine inference may lead to an inference that there is network congestion. The existence of network congestion may then become an inferred fact for a next iteration of the rule engine inference.

Upon an iteration of the rule engine outputting an inference which is the same as an inference output by a previous iteration of the rule engine, the inference may be determined to be a conclusion. Iterations of the rule engine may run until an iteration wherein no new inferences are output compared to a previous iteration. Each conclusion determined from all iterations of the rule engine may be output to a user interface of the software tool for review by a user.

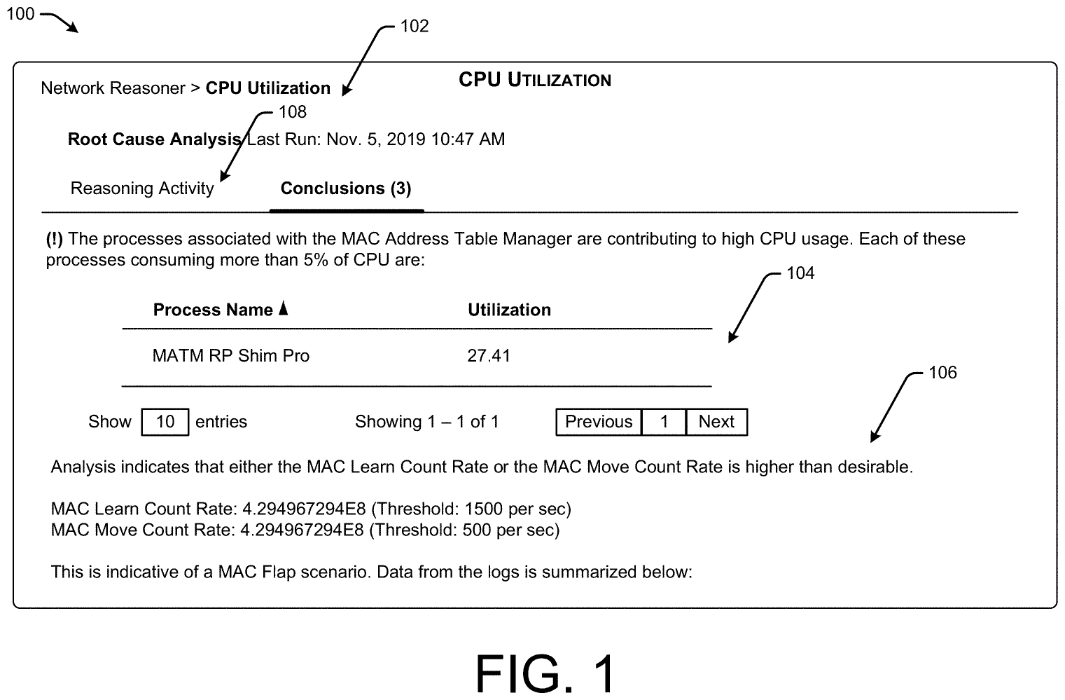

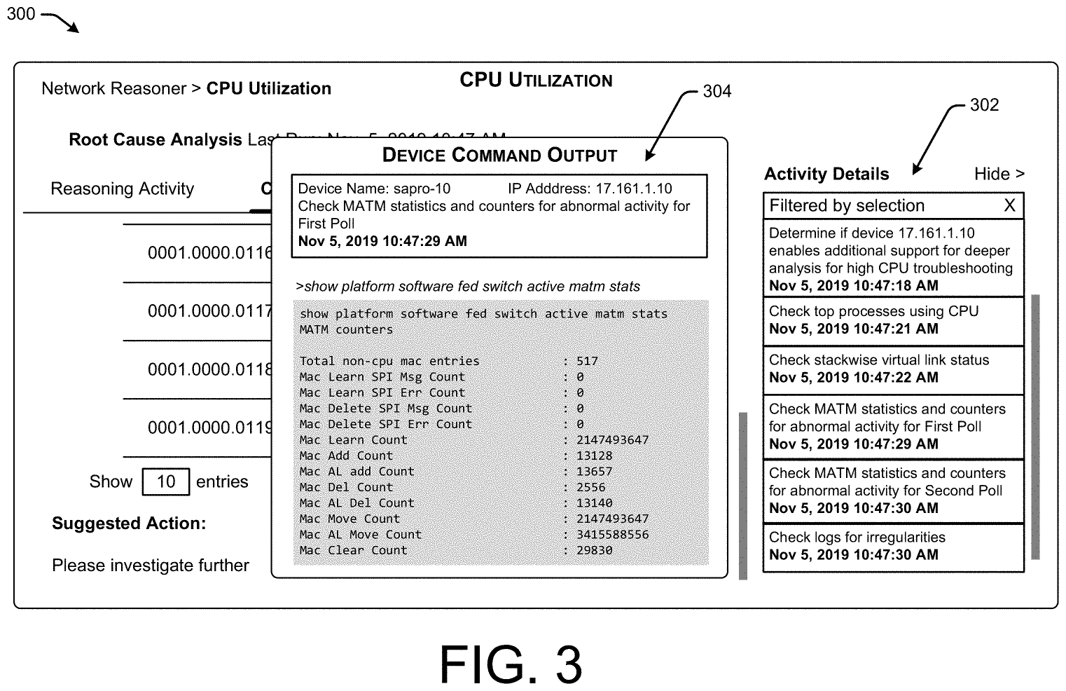

FIG. 1 illustrates an example of a conclusion view user interface 100 of a software tool according to example embodiments of the present disclosure. Herein, it is assumed that a user has already operated other user interfaces of the software tool (not illustrated herein) and input initialized parameters into the software tool, which were then utilized as parameters in computation of facts by iterations of running the rule engine to generate intermediate inferences, whereupon those intermediate inferences were then input at further iterations of running the rule engine as new facts. The user interface 100 may be designed in any suitable layout and configuration for presenting output conclusions from the rule engine in an organization suitable for informing a user of actionable conclusions. However, broadly, the conclusion view user interface 100 may include at least a scenario context 102, a conclusions view 104, and a facts view 106. According to example embodiments of the present disclosure, the user interface 100 may further include an expansion control 108, which shall be further discussed subsequently with reference to FIG. 3.

The scenario context 102 may display a category of scenarios that the user operates the user is seeking to diagnose by operating the software tool; as FIG. 1 illustrates, the scenario context may be “CPU Utilization,” meaning that the user wishes to diagnose causes of unusually high rates of total CPU capacity utilization by processes being run on one or more CPUs.

The conclusions view 104 may display at least some conclusions output by one or more iterations of the rule engine; these may be conclusions output at a final iteration of running the rule engine, or may be conclusions output at earlier iterations.

The supporting facts view 106 may display at least some conclusions output by one or more iterations of the rule engine which are supported by certain facts input into the rules engine; these may be facts input into any given iterations of the rule engine. Facts may be obtained from other modules, devices, or systems over a communication interface as described below.

According to example embodiments of the present disclosure, other than users inputting initialized parameters of the rules engine, such as variables of inference rules as described above, the rules engine may obtain facts from sources such as other modules, devices, or systems which are pertinent in the scenario context. For brevity, these sources may hereafter be referred to as “fact sources,” and those sources pertinent in the scenario context may hereafter be referred to as “context-relevant sources.” For example, in the event that the scenario context is increased network latency, context-relevant sources may include routers, switches, gateways, and such devices over which incoming network traffic pass over, at a local computing system, other computing systems hosted on a local network, at an interface between a local network and other networks, and the like. The rules engine may obtain facts from fact sources by sending instructions such as CLIs or REST API commands over a communication interface as described above to a fact source, causing the fact source to execute the instructions and return output over the communication interface. Based on communication protocols of the communication interface as known to persons skilled in the art, output returned over the communication interface may be parsed to obtain input facts for the rule engine. Each of these instances of sending instructions over a communication interface to a fact source and obtaining input facts from returned output may be referred to as a “diagnostic event” hereafter.

A common implementation of a rule engine is as a forward chaining rule engine. Forward chaining rule engines may compute rule sets in iterations, each iteration receiving facts as input; by comparing facts to each rule of the rule engine (such as conditional statements), rules having antecedents which match the facts may be activated, and the conclusions of those rules may be output as inferences. Such output inferences may be used as inferred facts for a next iteration of the rule engine inference. As a consequence of forward chaining implementations of a rule engine, after an iteration, the facts which were originally input into the rule engine cannot be reconstructed from the output inferences. Logically, this is a consequence of the fact that a conditional statement is not equivalent to its converse (e.g., M→N is not equivalent to N→M).

Consequently, a user of a software tool as described herein may run the software tool to cause various input to be obtained, and receive some number of conclusions as output, but may be unable to follow the process by which the facts trigger individual rules and by which individual rules output intermediate inferences.

Example embodiments of the present disclosure provide a workflow-based rule engine having context filters for rule engine reasoning. A rule engine according to example embodiments of the present disclosure may be implemented in any suitable programming or markup language suitable for expressing rules (hereafter “rule coding language”), such as the Semantic Web Rule Language (“SWRL”), based on the framework of the Web Ontology Language (“OWL”).

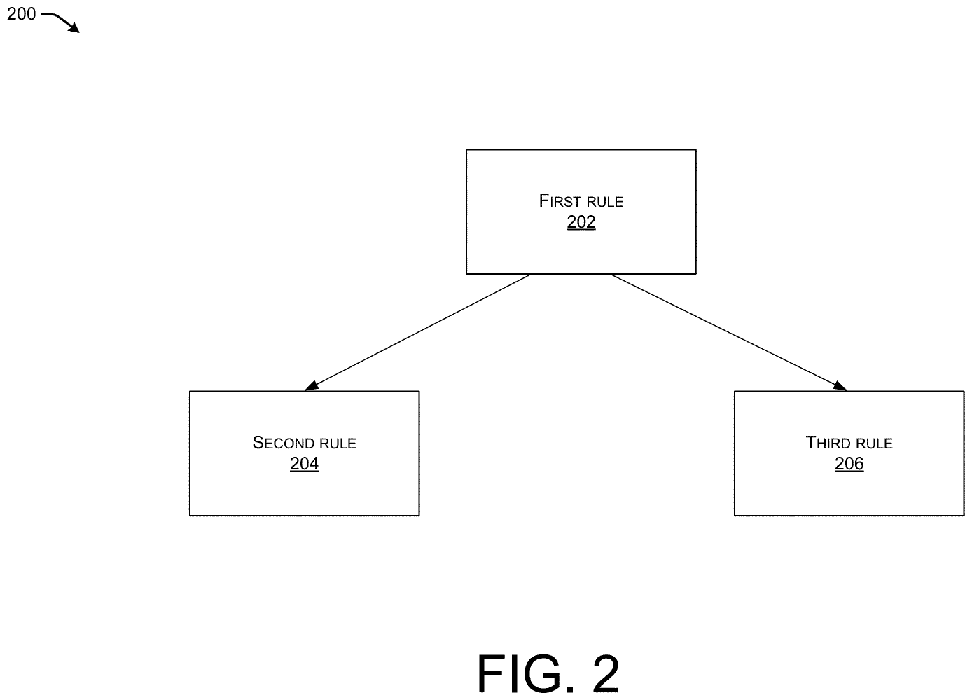

A rule engine according to example embodiments of the present disclosure may provide one or more workflows which relate different rules together through progressive logical interconnections. For example, FIG. 2 illustrates an example of a partial workflow 200 in accordance with the above example pertaining to network congestion. In the partial workflow 200, it may be unnecessary to consider rules premised upon network congestion being present until a rule is computed which outputs an inference that network congestion is present. Thus, a workflow may, as an example, start at a first rule 202 which includes a conditional statement which may conditionally output an inference of network congestion; the rule may conditionally lead to either a second rule 204 which is only relevant under network congestion conditions, or a third rule 206 which is only relevant under non-network-congestion conditions, continuing thereafter based on these respective premises.

Workflows according to example embodiments of the present disclosure may constitute structured decisions arranged in a tree structure, which may terminate at any number of leafs representing possible conclusions. A tree may be structured to start at a root decision and branch out to any number of node decisions, depending on inferences made at each decision based on running the rule engine with input facts. Certain rules may apply only on certain branches of the tree above certain nodes, below certain nodes, or between certain nodes and other nodes higher or lower. A tree may have cyclical structures. Rules of a tree are not guaranteed to be in a particular order relative to each other, further confounding the reconstruction of facts input into the rules engine from output inferences.

With regard to different possible scenario contexts as described above, a tree may include rules only pertinent to one scenario context. Alternately, a tree may include rules pertinent to multiple scenario contexts. According to example embodiments of the present disclosure, users may select different scenario contexts while operating a software tool, and selection of a different scenario context (such as CPU utilization, network latency, and the like) may cause the software tool to run rules of a different tree in order to diagnose facts pertaining to the different scenario context.

Workflows may be implemented by a rule coding language as described above. Workflows may be predefined as part of a software package for a software tool according to example embodiments of the present disclosure. Alternatively and/or additionally, workflows may be defined manually by a user based on the user's expertise regarding a scenario context. A user may operate a user interface of the software tool running on a computer system in order to define rules of a workflow (or select predefined rules, or select predefined rules having variable numerical thresholds and then define those numerical thresholds) and/or structure of a decision tree between rules of the workflow. The user may define structure of the decision tree by coding in a rule coding language on a text entry input interface of the software tool, or by selecting rules as visual elements and creating visual logical interconnections therebetween on a drawing, flowchart construction, or otherwise visual input interface of the software tool. These may also constitute initialized parameters input by a user as described above. In either case, the software tool may provide a compiler operative to convert input of the user into a structured decision tree interconnection various rules.

According to example embodiments of the present disclosure, a rule coding language may, in addition to providing syntax defining rules and syntax defining logical interconnections therebetween, further provide syntax defining a diagnostic event construct. A diagnostic event construct defined in a rule coding language according to example embodiments of the present disclosure may be a syntactical construct containing information regarding an event wherein facts are obtained during running of the rule engine.

For example, a diagnostic event construct may be defined to include a type of a diagnostic event, which may include obtaining facts from input and obtaining facts from fact sources as described above.

For example, a diagnostic event construct may be defined to include an event reference which may distinguish the diagnostic event construct from other defined diagnostic events constructs. Such a reference may be, for example, a key which contains a unique string of characters generated by an algorithm such as a unique identifier generation algorithm as known to persons skilled in the art.

For example, a diagnostic event construct may be defined to include a source reference which may distinguish the fact source from other fact sources. A source reference may similarly be a unique string generated as described above.

For example, a diagnostic event construct may be defined to include a source type which may identify whether the fact source is a module, device, system, network host, or any other such type of source, without limitation.

For example, a diagnostic event construct may be defined to include a command, which may be the same command which is sent over a communication interface to the fact source.

For example, a diagnostic event construct may be defined to include an output, which may be the same output which is received back over the communication interface from the fact source.

Several examples of diagnostic event constructs according to example embodiments of the present disclosure follows. Each individual example is enclosed in a pair of braces. Herein, the type as described above has the name “type”; the event reference as described above has the name “dynamicCommandContext”; the source reference as described above has the name “target”; the source type as described above has the name “targetType”; the command as described above has the name “targetCommand”; and the output as described above has the name “targetOutput.”

| | | | | |
|---|---|---|---|---|
| z | z | z | z | z |

{

| | |
|---|---|
| “workflowExecutionId”: | “2da5b741-b25e-49a4-a0bd-5978a7e5d698”, |
| “instanceUuid”: | “c8e902ff-ce55-45c9-be0a-162ba82946b3”, |

| | |
|---|---|
| “type”: | “COMMAND_COMPLETED”, |

“ontologyIri”:
“http://www.cisco.com/CNSR/ShowTopProcesses/0.0.0”,

| | |
|---|---|
| “dynamicCommandContext”: | [ |

“ba82f1bf-5350-4ae9-9de0-d4f5ac475a50”
],

| | |
|---|---|
| “target”: | “62d69d84-4155-4d33-b89c-a58f16e2b13d”, |

| | |
|---|---|
| “targetType”: | “DEVICE”, |

“targetCommand”: “show processes cpu sorted 5min | ex 0.00\n”,
“targetOutput”: “show processes cpu sorted 5min | ex 0.00\nCPU
utilization for five seconds: 99%/1%; one minute: 99%; five
minutes: 99%\n PID Runtime (ms) Invoked uSecs 5Sec 1Min 5Min TTY
Process \n 532 409710152 157029125 2609 66.47% 64.19% 64.16% 0
SNMP Traps \n 164 203625156 174451314 1167 28.07% 27.42% 27.41%
0 MATM RP Shim Pro \n 124 956711 6069162 157 13.43% 8.94% 8.48%
0 IOSXE-RP Punt Se \n 80 19232119 182798263 105 2.23% 2.28% 2.32%
0 IOSD ipc task \n 100 11744434 195030149 60 1.35% 1.59% 1.65%
0 NGWC Learning Pr \n 527 23100169 2295597565 0 0.07% 0.17% 0.18%
0 IP SLAs XOS Even \n 466 2480706 106659345 23 0.07% 0.08% 0.08%
0 IP SNMP \n 310 10134716 6176696 1640 0.07% 0.07% 0.05% 0 Flow
Exporter Ti \n 110 3511135 55383805 63 0.07% 0.03% 0.03% 0

| | | | |
|---|---|---|---|
| Crimson | config | p | \nc9407R-1#” |

| | |
|---|---|
| “status”: | “SUCCESS”, |

| | |
|---|---|
| “timestamp”: | 1572979641182 |

}
{

| | |
|---|---|
| “workflowExecutionId”: | “2da5b741-b25e-49a4-a0bd-5978a7e5d698”, |
| “instanceUuid”: | “3494e217-5ed1-4687-a778-435f4acb1a47”, |

| | |
|---|---|
| “type”: | “COMMAND_COMPLETED”, |

“ontologyIri”:
“http://www.cisco.com/CNSR/SVLMATMHighCPUTroubleshoot/0.0.0”

| | |
|---|---|
| “dynamicCommandContext”: | [ |

“57596762-b9b6-482f-bcab-e76aaa79eb72”
],

| | |
|---|---|
| “target”: | “62d69d84-4155-4d33-b89c-a58f16e2b13d”, |

| | |
|---|---|
| “targetType”: | “DEVICE”, |

“targetCommand”: “snow platform software fed switch active matm
stats\n”,
“targetOutput”: “show platform software fed switch active matm
stats\nMATM counters\n\nTotal non-cpu mac entries : 517\nMac
Learn SPI Msg Count : 0\nMac Learn SPI Err Count : 0\nMac Delete
SPI Msg Count : 0\nMac Delete SPI Err Count : 0\nMac Learn Count :
4294977294\nMac Add Count : 13128\nMac AL add Count : 13657\nMac
Del Count : 2556\nMac AL Del Count : 13140\nMac Move Count :
4294977294\nMac AL Move Count : 3415588556\nMac Clear Count :
29830\nMac Del all count : 104\nMac table create Count : 14\nMac
VP event Count : 35\nMac Update info Count : 0\nMac Vlan age
config Event Count : 0\nMac Vlan Link Event Count : 32\nMac SVI
linkEvent Count : 13\nMac Bsync Event Count : 0\nMac Isync Event
Count : 0\nMac Recon Start Count : 0\nMac Recon Event Count :
0\nMac IFM event Count : 451\nMac FEC Event Count : 0\nMac Aging
Tick Count : 0\nMac Retry event Count : 0\nMac Hw Update Err
Count : 0\nMac. In retryQ Count : 0\nMac Polling Timer Count :
0\nMac Lisp Local Add Count : 0\nMac Lisp Remote Add Count :
0\nMac: Lisp Local Move Count : 0\nMac Lisp Remote Move Count :

| | | | | | |
|---|---|---|---|---|---|
| 0\nMac | Lisp | Delete | Count | : | 0\nc9407R-1#” |

| | |
|---|---|
| “status”: | “SUCCESS”, |

| | |
|---|---|
| “timestamp”: | 1572979650343 |

}
{

| | |
|---|---|
| “workflowExecutionId”: | “2da5b741-b25e-49a4-a0bd-5978a7e5d698”, |
| “instanceUuid”: | “8654d730-e461-4326-86e5-44fec5d10f34”, |

| | |
|---|---|
| “type”: | “COMMAND_COMPLETED”, |

“ontologyIri”:
“http://www.cisco.com/CNSR/SVLMATMHighCPUTroubleshoot/0.0.0”,

| | |
|---|---|
| “dynamicCommandContext”: | [ |

“6d3b9361-4d8e-435f-93f6-688123496a71”
],

| | |
|---|---|
| “target”: | “62d69d84-4155-4d33-b89c-a58f16e2b13d”, |

| | |
|---|---|
| “targetType”: | “DEVICE”, |

“targetCommand”: “show logging | MACFLAP_NOTIF”,
“targetOutput”: “\nOct 18 2019 21:54:47.258 UTC: %SW_MATM-4-
MACFLAP_NOTIF: Host 0001.0000.01b0 in vlan 401 is flapping
between port Gi1/0/20 and port Gi1/0/19\nOct 18 2019
21:54:47.271 UTC: %SW MATM-4-MACFLAP NOTIF: Host 0001.0000.0187
in vlan 401 is flapping between port Gi1/0/19 and port
Gi1/0/20\nOct 18 2019 21:54:47.271 UTC: %SW_MATM-4-
MACFLAP_NOTIF: Host 0001.0000.0188 in vlan 401 is flapping
between port Gi1/0/19 and port Gi1/0/20\nOct 18 2019
21:54:47.271 UTC: %SW_MATM-4-MACFLAP_NOTIF: Host 0001.0000.0189
in vlan 401 is flapping between port Gi1/0/19 and port
Gi1/0/20\nOct 18 2019 21:54:47.271 UTC: %SW_MATM-4-
MACFLAP_NOTIF: Host 0001.0000.018a in vlan 401 is flapping
between port Gi1/0/19 and port Gi1/0/20\nOct 18 2019
21:54:47.271 UTC: %SW MATM-4-MACFLAP NOTIF: Host 0001.0000.018b
in vlan 401 is flapping between port Gi1/0/20 and port
Gi1/0/19\nOct 18 2019 21:54:47.271 UTC: %SW_MATM-4-
MACFLAP_NOTIF: Host 0001.0000.018c in vlan 401 is flapping

| | | | | | |
|---|---|---|---|---|---|
| between | port | Gi1/0/20 | and | port | Gi1/0/19\n”, |

| | |
|---|---|
| “status”: | “SUCCESS”, |

| | |
|---|---|
| “timestamp”: | 1572979650560 |

}

According to example embodiments of the present disclosure, a rule coding language may further provide syntax defining an inference construct. An inference construct according to example embodiments of the present disclosure may be a syntactical construct containing any number of event references to diagnostic event constructs, by their event references as described above. Particularly, the diagnostic event constructs may correspond to those diagnostic events which output facts which triggered inference rules of the rule engine which output an inference of the inference construct.

For example, an inference construct may further be defined to include an inference statement, which may be a statement of an inference output by the rules engine as a conclusion which may be displayed in a conclusion view 104 as described above with reference to FIG. 1.

An example of a conclusion construct according to an example embodiment of the present disclosure follows. The example is enclosed in a pair of braces. Herein, the event references as described above collectively have the name “dynamicCommandContext”; and the inference statement as described above has the name “message.”

{

| | |
|---|---|
| “workflowExecutionId”: | “2da5b741-b25e-49a4-a0bd-5978a7e5d698”, |
| “instanceUuid”: | “9a326513-61f5-4db6-a909-cb5e2afcb368”, |

| | |
|---|---|
| “type”: | “CONCLUSION”, |

“ontologyIri”:
“http://www.cisco.com/CNSR/SVLMATMHighCPUTroubleshoot/0.0.0”,

| | |
|---|---|
| “dynamicCommandContext”: | [ |

“6d3b9361-4d8e-435f-93f6-688123496a71”,
“57596762-b9b6-482f-bcab-e76aaa79eb72”,
“ba82f1bf-5350-4ce9-9de0-d4f5ac475a50”
],
“message”: “The processes associated with the MAC Address Table
Manager are contributing to high-cpu usage. Analysis indicates
that either the MAC Learn Count Rate or the MAC Move Count Rate
is higher than desirable: MAC Learn Count Rate: 4.294967294E8
(Threshold: 1500 per sec) MAC Move Count Rate: 4.294967294E8
(Threshold: 500 per sec). This is indicative of a MAC Flap
scenario. Data from the logs is summarized below:”,

| | |
|---|---|
| “category”: | “ROOT_CAUSE”, |
| “timestamp”: | 1572979650959 |

}

According to example embodiments of the present disclosure, upon a rule engine outputting an inference, it may generate an inference construct having references to each diagnostic event construct corresponding to a diagnostic event which, at some point, output facts which triggered inference rules of the rule engine outputting an inference of the inference construct. These diagnostic events may have relevance for users seeking to audit reasoning of the rule engine after the rule engine has output conclusions. In contrast, diagnostic events which output facts which did not trigger inference rules may not have relevance for users seeking to audit reasoning of the rule engine, and thus references to constructs of those diagnostic events may not be included in the inference construct.

Example embodiments of the present disclosure further provide, as FIG. 3 illustrates by way of example, an expanded view user interface 300 of a software tool according to example embodiments of the present disclosure. Upon selecting the expansion control 108 as illustrated in FIG. 1, while a conclusion view user interface 100 is displaying information of an inference construct, a user may cause a display interface of the computing system to change display from a conclusion view user interface 100 to an expanded view user interface 300. The expanded view user interface may display, in addition to any or all elements of the conclusion view user interface 100 and a diagnostic events list 302. The diagnostic events list 302 may list each diagnostic event construct referenced in a displayed inference construct. Contents of the diagnostic events list 302 may be constructed by looking up, for each event reference listed in the inference construct, a diagnostic event construct having an event reference matching the listed event reference.

Information of the diagnostic event construct may be displayed to provide a descriptive indication of the purpose of the diagnostic event, such information including type, source type, and command. Such information may be used to generate descriptive wording to improve a user's understanding of the purpose of the diagnostic event. It may be seen that more diagnostic event constructs are listed than shown in the example conclusion construct above, as some event references were excluded in the above example for brevity. The information of diagnostic events corresponding to the conclusions includes one or more event references, each of which identifies an earlier diagnostic event which corresponds to an intermediate inference. Tracing event references backwards may allow all events linked to the conclusions by event references to be shown. Thus, the diagnostic events list 302 may exclude events during iterations of the rule engine which do not link to the conclusion by event references.

The user may operate an input interface of the computing system to select a diagnostic event construct from the diagnostic events list 302 to cause the computing system to update the expanded view user interface 300 to further include a diagnostic event view 304. The diagnostic event view 304 may provide detailed display of information of the selected diagnostic event construct, such as, for example, the output of the selected diagnostic event.

Thus, example embodiments of the present disclosure provide software tools wherein auditability is enhanced for reasoning of underlying rules engines. In practice, A user operating a computing system to run the software tool as described above in a scenario context may view the conclusion view user interface 100 after the rule engine has finished executing a workflow. However, while a user may merely view the conclusions displayed in the conclusion view user interface 100, the user may need to further audit reasoning by which the rule engine derived the conclusion, and compare the reasoning to the user's own knowledge or sanity-check the reasoning in order to be able to trust or rely on the conclusion, or be able to communicate the reasoning to third parties to enable the third parties to be able to trust or rely on the conclusion. Thus, the conclusion view user interface 100 provides an expansion control 108 such that a user may interact with the expansion control 108 using an input interface of the computing device to open an expanded view user interface 300 as illustrated in FIG. 3.

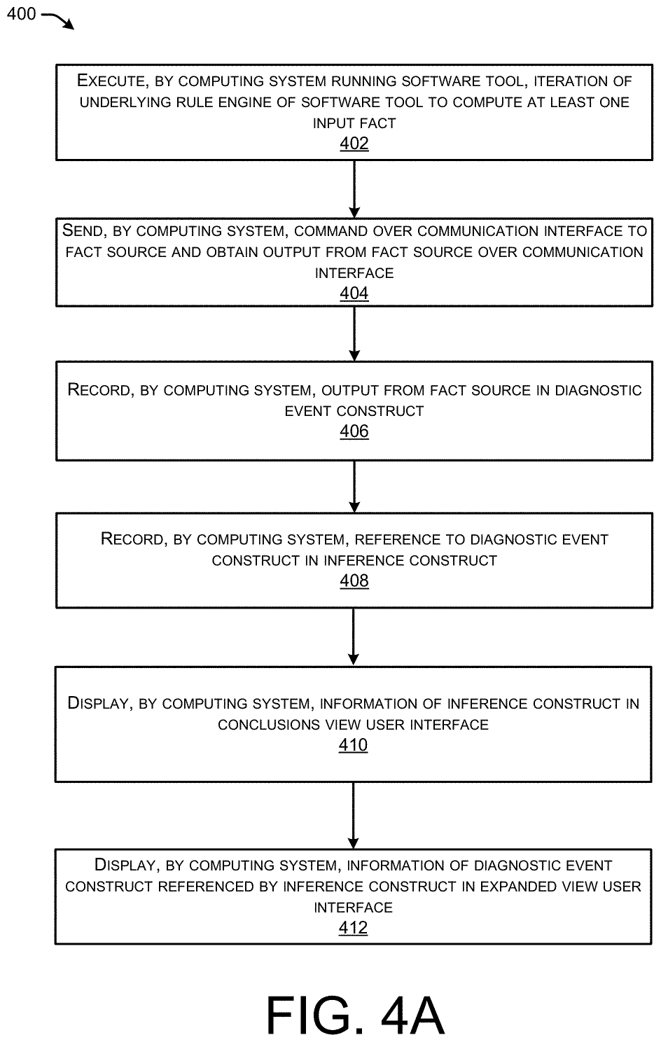

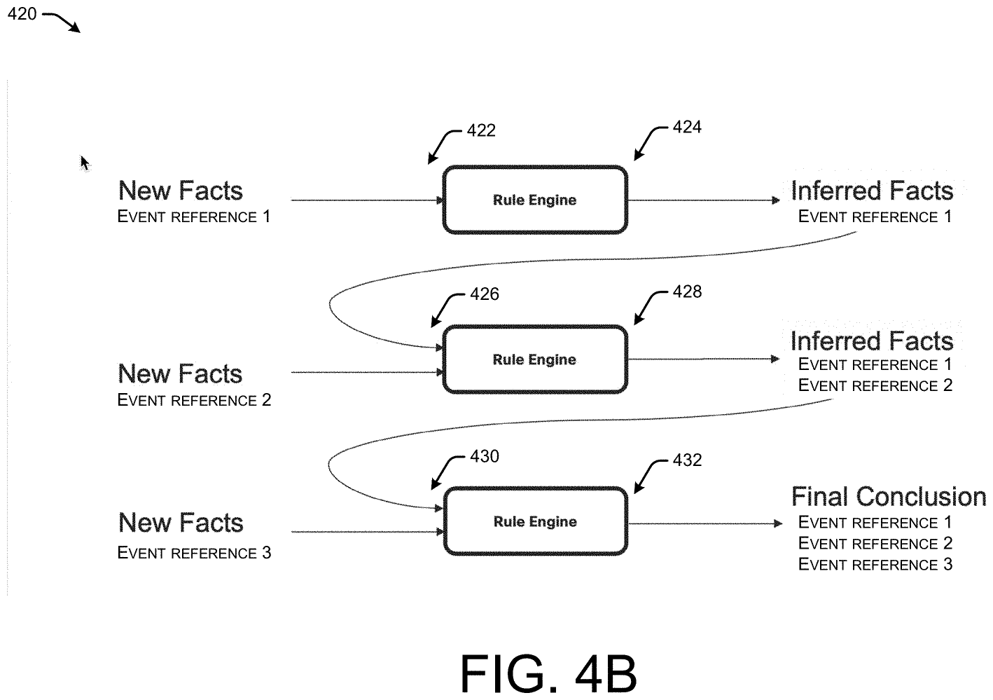

Example embodiments of the present disclosure further provide a workflow computing method incorporating cross-references between diagnostic event constructs and inference constructs. FIG. 4A illustrates a flowchart of an example workflow computing method according to example embodiments of the present disclosure.

At step 402, a computing system running a software tool executes an iteration of an underlying rule engine of the software tool to compute at least one input fact.

As described above, a user may, through an input interface, operate various user interfaces of the software tool running on a computing system to cause the computing system to run iterations of the rule engine to compute input facts. The computations may be in a particular scenario context, which may be a dedicated scenario context for the software tool (such as a specialized software tool for diagnosing one particular scenario context), or may be one out of multiple scenario contexts. The computations may be in the context of a particular workflow, which may be one out of several workflows.

At step 404, the computing system sends a command over a communication interface to a fact source and obtains an output from the fact source over the communication interface.

In general, the computing system proceeding through rules of the workflow may prompt the sending of such commands in the event that rules of the workflow require assessment of facts which need to be obtained from fact sources. As described above, fact sources may be modules, devices, systems, host servers on a network, and any other type of electronic component having communication capabilities over a communication interface, without limitation. Communication interfaces may be, for example, those described above, without limitation.

At step 406, the computing system records the output from the fact source in a diagnostic event construct.

As described above, the command being sent over the communication interface to the fact source may be considered as a diagnostic event, and information relating to the diagnostic event, such as type, source reference, source type, command, and output may be recorded in the diagnostic event construct. An event reference as described above may be further generated and recorded in the diagnostic event construct to uniquely identify the diagnostic event construct among other diagnostic event constructs.

At step 408, the computing system records a reference to the diagnostic event construct in an inference construct.

As described above, upon the rule engine outputting an inference during an iteration of the rule engine, the computing system may record information of the inference in an inference construct, including an inference statement. At this time the computing system may also determine each diagnostic event which output a fact which caused the rule engine to output the inference. The computing system may record an event reference of a diagnostic event construct of each such determined diagnostic event in the inference construct.

At step 410, the computing system displays information of the inference construct in a conclusion view user interface.

As described above, upon the rule engine outputting an inference determined to be a conclusion (which may be determined from iterations of the rule engine as described above), information of an inference construct corresponding to the inference determined to be a conclusion may be displayed in a conclusion view user interface, an example of which being illustrated above in FIG. 1. For example, an inference statement as described above may be displayed in a conclusions view of the user interface.

At step 412, the computing system displays information of the diagnostic event construct referenced by the inference construct in an expanded view user interface, an example of which being illustrated above in FIG. 3. For example, the output of the selected diagnostic event may be displayed in the expanded view user interface.

FIG. 4B illustrates a flowchart of iterations 420 of a rule engine in accordance with the example workflow computing method. At steps 422, 426, and 430, a computing system inputs facts into a rule engine. At steps 424, 428, and 432, execution of the rule engine by the computing system causes the rule engine to output inferences. At steps 426 and 430, the input facts may include new facts and may include inferred facts from steps 424 and/or 428. Each input fact may be associated with a diagnostic event having an associated event reference, as illustrated.

By a method as described herein, a computing system running a software tool may record information pertaining to reasoning of an underlying rule engine of the software tool with regard to a scenario context in constructs such as inference constructs and diagnostic event contexts, so that a user operating the software tool running on the computing system may trace back the reasoning that led to each conclusion through diagnostic events which provided facts which caused the rule engine to output the conclusion.

In the diagnosis of scenario contexts in complex technological systems such as physical or virtual network infrastructure, support personnel may run a software tool according to example embodiments of the present disclosure and input facts into the software tool to obtain a conclusion output by a rule engine which may be relied upon to identify sources of the scenario context. The support personnel may further view the expanded view user interface to view information of diagnostic events linked to any number of conclusions, which may be traced backwards by event references, allowing reasoning of the rule engine to be reconstructed from the conclusions. This may enable support personnel, and recipients of support from those support personnel, to trust the conclusions prior to relying thereon.

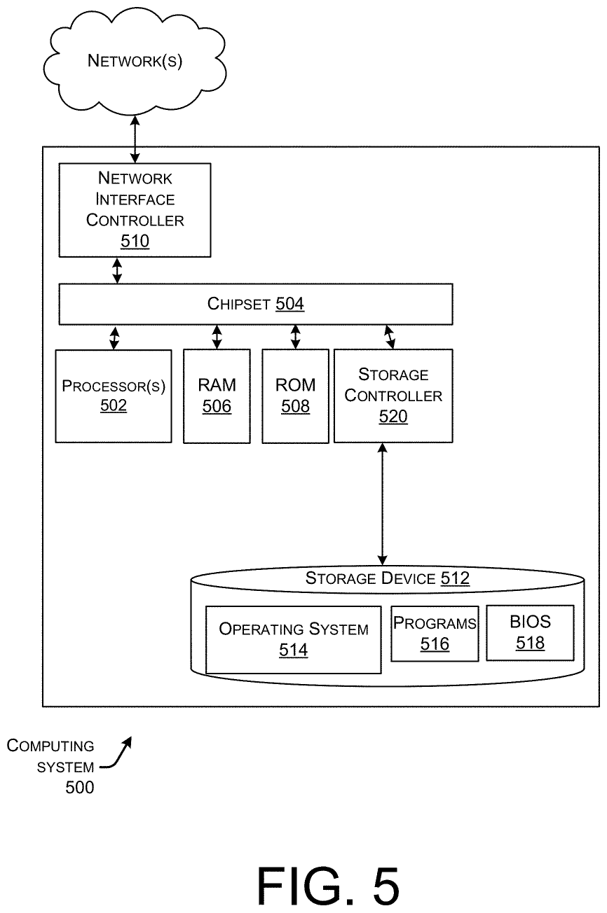

FIG. 5 illustrates an example system architecture of a computing system 500 configured to run a software tool and perform rule engine computations according to example embodiments of the present disclosure.

According to example embodiments of the present disclosure, a computing system 500 may include any number of processor(s) 502. The processor(s) 502 may be physical processors and/or may be virtual processors, and may include any number of physical and/or virtual cores. The processor(s) 502 may each be configured to execute one or more instructions stored on a computer-readable storage medium, such as models as described above, to cause the processor(s) 502 to compute tasks such as rule engine iterations as described above.

The processor(s) 502 may perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

In one illustrative configuration, the processor(s) 502 operate in conjunction with a chipset 504. The chipset 504 provides an interface between the processor(s) 502 and the remainder of the components and devices of the computing system 500. The chipset 504 can provide an interface to a RAM 506, used as the main memory in the computing system 500. The chipset 504 can further provide an interface to a computer-readable storage medium such as a read-only memory (“ROM”) 508 or non-volatile RAM (“NVRAM”) for storing basic routines that help to startup the computing system 500 and to transfer information between the various components and devices. The ROM 508 or NVRAM can also store other software components necessary for the operation of the computing system 500 in accordance with the configurations described herein.

The computing system 500 may operate in a networked environment using logical connections to remote computing devices and computer systems through a network. The chipset 504 may include functionality for providing network connectivity through a NIC 510, such as a gigabit Ethernet adapter. The NIC 510 is capable of connecting the computing system 500 to other computing devices over a network. It should be appreciated that multiple NICs 510 may be present in the computing system 500, connecting the computing system 500 to other types of networks and remote computer systems.

The computing system 500 may be connected to a storage device 512 that provides non-volatile storage for the computing system 500. The storage device 512 may store an operating system 514, programs 516, a BIOS 518, and data, which have been described in greater detail herein. The storage device 512 may be connected to the computing system 500 through a storage controller 520 connected to the chipset 504. The storage device 512 may consist of one or more physical storage units. The storage controller 520 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing system 500 may store data on the storage device 512 by transforming the physical state of the physical storage units to reflect the information being stored. The specific transformation of physical state may depend on various factors, in different embodiments of this description. Examples of such factors may include, but are not limited to, the technology used to implement the physical storage units, whether the storage device 512 is characterized as primary or secondary storage, and the like.

For example, the computing system 500 may store information to the storage device 512 by issuing instructions through the storage controller 520 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing system 500 may further read information from the storage device 512 by detecting the physical states or characteristics of one or more particular locations within the physical storage units.

In addition to the storage device 512 described above, the computing system 500 may have access to other computer-readable storage media to store and retrieve information, such as program modules, data structures, or other data. It should be appreciated by those skilled in the art that computer-readable storage media is any available media that provides for the non-transitory storage of data and that may be accessed by the computing system 500. In some examples, the operations performed by a router node of the network overlay, and or any components included therein, may be supported by one or more devices similar to the computing system 500. Stated otherwise, some or all of the operations performed for computing rule engines may be performed by one or more computing systems 500 operating in a networked, distributed arrangement over one or more logical planes over one or more networks.

By way of example, and not limitation, computer-readable storage media may include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that may be used to store the desired information in a non-transitory fashion.

As mentioned briefly above, the storage device 512 may store an operating system 514 utilized to control the operation of the computing system 500. According to one embodiment, the operating system comprises the LINUX operating system and derivatives thereof. According to another embodiment, the operating system comprises the WINDOWS operating system from MICROSOFT CORPORATION of Redmond, Wash. It should be appreciated that other operating systems may also be utilized. The storage device 512 may store other system or application programs and data utilized by the computing system 500.

In one embodiment, the storage device 512 or other computer-readable storage media is encoded with computer-executable instructions which, when loaded into a computer, transform the computer from a general-purpose computing system into a special-purpose computer capable of implementing the embodiments described herein. These computer-executable instructions transform the computing system 500 by specifying how the processor(s) 502 transition between states, as described above. According to one embodiment, the computing system 500 has access to computer-readable storage media storing computer-executable instructions which, when executed by the computing system 500, perform the various processes described above with regard to FIGS. 1-4. The computing system 500 may also include computer-readable storage media having instructions stored thereupon for performing any of the other computer-implemented operations described herein.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A system comprising:
one or more processors; and
one or more non-transitory computer-readable media storing computer-executable instructions that, when executed by the one or more processors, cause the one or more processors to:
execute an iteration of a rule engine to compute at least one input fact;
send a command over a communication interface to a fact source and obtain an output from the fact source over the communication interface; and
record the output from the fact source in a diagnostic event construct.

2. The system of claim 1, wherein the instructions further cause the one or more processors to record a source reference, a source type, and the command in the diagnostic event construct.

3. The system of claim 1, wherein the instructions further cause the one or more processors to record an event reference in the diagnostic event construct.

4. The system of claim 3, wherein the instructions further cause the one or more processors to record the event reference in an inference construct.

5. The system of claim 4, wherein the instructions further cause the one or more processors to display information of the inference construct in a conclusion view user interface.

6. The system of claim 5, wherein the instructions further cause the one or more processors to display information of the diagnostic event construct referenced by the inference construct in an expanded view user interface.

7. The system of claim 4, wherein the instructions further cause the one or more processors to display information of the diagnostic event construct in a diagnostic events list in a conclusion view user interface, the diagnostic events list excluding information of diagnostic event constructs having event references which are not recorded in the inference construct.

8. A method comprising:
executing, by a computing system, an iteration of a rule engine to compute at least one input fact;
sending, by the computing system, a command over a communication interface to a fact source and obtain an output from the fact source over the communication interface; and
recording, by the computing system, the output from the fact source in a diagnostic event construct.

9. The method of claim 8, further comprising recording a source reference, a source type, and the command in the diagnostic event construct.

10. The method of claim 8, further comprising recording an event reference in the diagnostic event construct.

11. The method of claim 10, further comprising recording the event reference in an inference construct.

12. The method of claim 11, further comprising displaying information of the inference construct in a conclusion view user interface.

13. The method of claim 12, further comprising displaying information of the diagnostic event construct referenced by the inference construct in an expanded view user interface.

14. The method of claim 11, further comprising displaying information of the diagnostic event construct in a diagnostic events list in a conclusion view user interface, the diagnostic events list excluding information of diagnostic event constructs having event references which are not recorded in the inference construct.

15. A system comprising:
one or more processors; and
one or more non-transitory computer-readable media storing computer-executable instructions that, when executed by the one or more processors, cause the one or more processors to:
display a conclusion view user interface comprising an inference statement of an inference construct, the inference construct comprising at least one event reference; and
display an expansion control operable to change display from the conclusion view user interface to an expanded view user interface, the expanded view user interface comprising a diagnostic events list.

16. The system of claim 15, wherein the diagnostic events list comprises information of at least one diagnostic event construct having an event reference matching an event reference of the inference construct.

17. The system of claim 15, wherein the diagnostic events list excludes information of diagnostic event constructs having event references not matching an event reference of the inference construct.

18. The system of claim 15, wherein information of a diagnostic event construct comprises a source reference recorded in the diagnostic event construct, a source type recorded in the diagnostic event construct, and a command recorded in the diagnostic event construct.

19. The system of claim 18, wherein information of a diagnostic event construct further comprises descriptive wording generated from the source reference, the source type, and the command.

20. The system of claim 15, wherein the instructions further cause the one or more processors to display a diagnostic event view comprising output stored in the diagnostic event construct.
